(19) United States
(12) Patent Application Publication
(10) Pub. No.: US 2005/0089182 A1
(43) Pub. Date: Apr. 28, 2005

(54) Compact surround-sound system

(76) Inventors: Paul Thomas Troughton, Cambridge (GB); Irving Alexander Bienek, Cambridge (GB); Mark Richard Shepherd, Royston (GB)

Correspondence Address: ELMAN TECHNOLOGY LAW, P.C., P. O. BOX 209, SWARTHMORE, PA, 19081-0209, US

(21) Appl. No.: 10/504,194

(22) PCT Filed: Feb. 17, 2003
(86) PCT No.: PCT/GB03/00672

(30) Foreign Application Priority Data
Feb. 19, 2002 (GB) 0203895.8

(51) Int. Cl. H04R 5/02; H04R 5/00

(52) U.S. Cl. 381/307; 381/18

(57) ABSTRACT

An audio system for producing a plurality of surround-sound channels in response to an audio input signal, comprising in a single enclosure an amplifier system adapted to receive surround sound input signals and a plurality of electro-acoustic transducers arranged in part as phased array and adapted to emit surround sound based on said surround sound input signals, wherein the enclosure includes at least one left and at least one right electro-acoustic transducer and filters to divert low-frequency content of said input signals for emission through said left and right transducers.

### FIELD OF THE INVENTION

This invention relates to a surround-sound system having multiple channels for immersing a listener in a multi-directional sound field. More specifically, the invention pertains to a surround-sound system capable of generating surround sound from a single compact enclosure.

### BACKGROUND OF THE INVENTION

Recent years have seen widespread use of multi-channel stereophonic sound in audio/visual systems. The trend in the technology has been away from conventional stereo sound reproduction systems, and toward “surround sound” techniques where the sound field is dynamically (and intentionally) shifted to the sides of and behind the listener.

To improve listener perceived characteristics, multi-channel sound reproduction systems are known which include one or more surround-sound channels (often referred to in the past as “ambience” or “special-effects” channels) in addition to left and right (and optimally, centre) sound channels. These systems are now relatively common in motion picture theatres and are becoming more and more common in the homes of the customers. A driving force behind the proliferation of such systems in consumers' homes is the widespread availability of surround-sound home video software, mainly surround-sound motion pictures (movies) made for theatrical release and subsequently transferred to home video media (e.g., digital video discs (DVDs), videocassettes, videodisks, and broadcast or cable television).

In the case where sound is reproduced in such a way as to provide a sound field expanding behind a listener or to localize a sound image behind a listener, two (front) loudspeakers are arranged to the left and right front of a listener for left and right channel reproduction and at least one or two rear loudspeakers are additionally arranged behind the listener for surround or rear channel reproduction. In addition, modern surround sound systems may include a centre speaker arranged in front of the listener between the front left and the front right speaker. To improve sound quality, a low-frequency part of the audio signal may be directed to an additional subwoofer. The exact position of the subwoofer with respect to a listener is not critical to the overall performance of the surround-sound system.

In ordinary homes, however, it is difficult to arrange five to six loudspeakers in a room. As new surround sound systems are often incompatible with any existing stereo systems, a user is left with the choice of having two co-existing systems in one room (bringing the number of speakers up to seven or eight) or to discard the old system. This being clearly unsatisfactory, attempts have been made in recent years to reduce the number of speakers to generate surround sound or to at least provide for a better integration between new surround sound systems and any legacy stereo equipment.

The most advanced system aiming at reducing the number of hardware components is described in the commonly-owned published International Patent application No. WO-0123104. In WO-0123104, an array of transducers generates a number of independently steerable sound beams. In operation the sound beams are directed at suitable locations of reflecting surfaces or walls left and right of a listener and towards the left and right corners of the wall behind the listener. The reflected sounds converge towards the listener position, the so-called “sweet spot”, in very much the same manner as if projected from loudspeakers located at those positions. Hence, the system disposes of the need to have speakers in more than one location of the room.

While being satisfactory for many applications, there is perceived the need to reduce the overall dimensions of such as system in order to facilitate installation in smaller rooms.

It is therefore an object of the invention to improve the apparatus of WO-0123104 so as to produce a system capable of generating surround sound from a single enclosure having dimensions comparable to those of conventional television sets.

### SUMMARY OF THE INVENTION

In view of the above objects, the present invention provides an apparatus as claimed in the independent claims.

According to a first aspect of the invention, there is provided an audio system for producing a plurality of surround-sound channels in response to an audio input signal, comprising, in a single enclosure or housing, an amplifier system adapted to receive surround sound input signals and a plurality of electro-acoustic transducers some of which are arranged as a phased array adapted to emit surround sound based on said surround sound input signals by directing surround sound channels in different directions, wherein the enclosure includes at least one left and at least one right electro-acoustic transducer and filters to divert low-frequency content of said input signals for emission through said left and right transducers.

Essentially the invention is a compact surround-sound system capable of generating at a listener position a true surround-sound environment from a housing of the size of a conventional television set, making use of at least two woofer speakers, each located at a side faces of the enclosures, and a phased array of transducers located at the front face.

In a first embodiment of the invention, the woofer speakers are used for the reproduction of low frequency content of the surround-sound signals, while the transducer array generates the left, right, centre, surround left/right and other channels present in the signals.

In more preferred embodiment, the system includes an emission mode control for fast adaptation to different environments. More specifically, the novel audio system is capable of varying the modes in which the left and right channel of a surround-sound reproduction is emitted, enabling transducers to be activated or deactivated for the purpose of emitting specific channels. The novel feature enhances the usability of the system in various environments and for various user preferences.

These and other aspects of inventions will be apparent from the following detailed description of non-limitative examples making reference to the following drawings.

### BRIEF DESCRIPTION OF THE DRAWINGS

In the drawings:

FIG. 1A is a perspective view of an audio system in accordance with the present invention;

FIG. 1B is a horizontal cross-section of the system of FIG. 1A;

FIG. 2 is a block diagram of an audio system in accordance with the invention;

FIG. 3 is a schematic diagram illustrating a part aspect of the system of FIG. 2;

FIG. 4 is a schematic diagram illustrating further details of the system of FIG. 2; and

FIG. 5 illustrates details the emission mode control of the system of FIG. 2.

### DETAILED DESCRIPTION

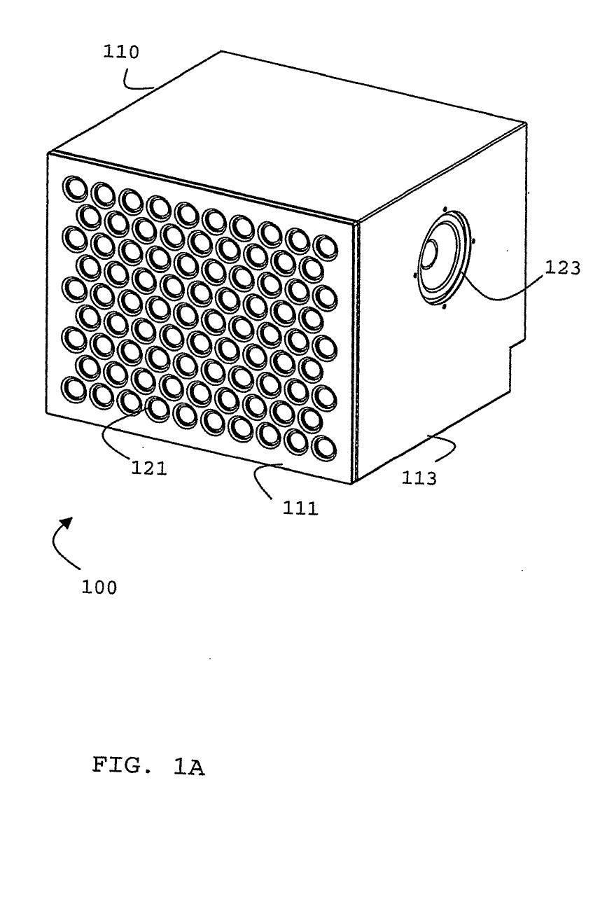

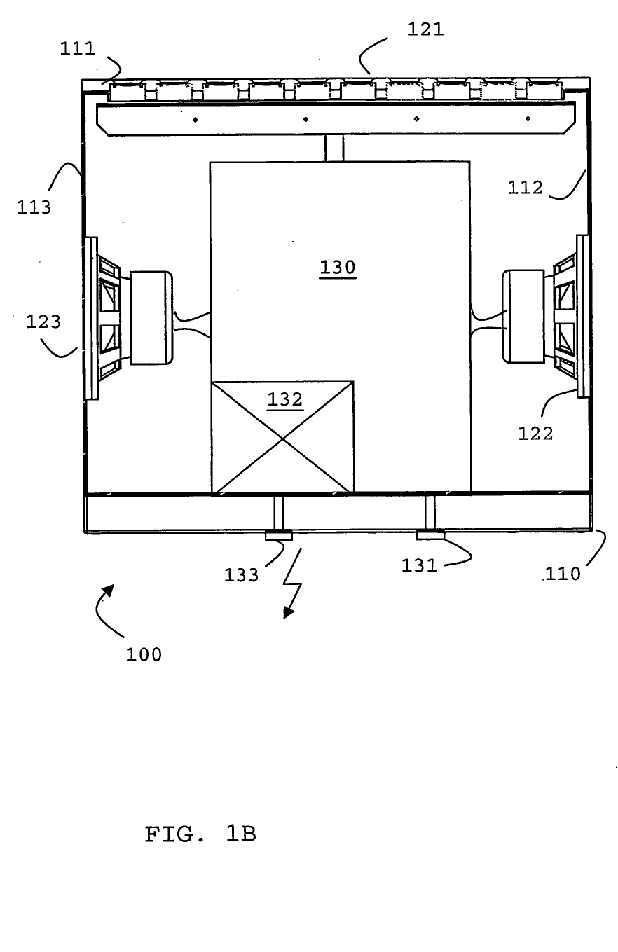

In the drawings of FIG. 1, there is shown an audio system 100 having a single enclosure (or housing) 110. The front panel 111 carries an array of transducers 121. The left and right side face 112, 113 are used to mount a left and right woofer loudspeaker 122 (WL),123 (WR) respectively. Further enclosed with the enclosure 110 is an amplifier section 130 connected to external audio signal sources, such as DVD players or receivers, through an input socket 131. The amplifier section has a power unit 132 fed by a mains supply 133.

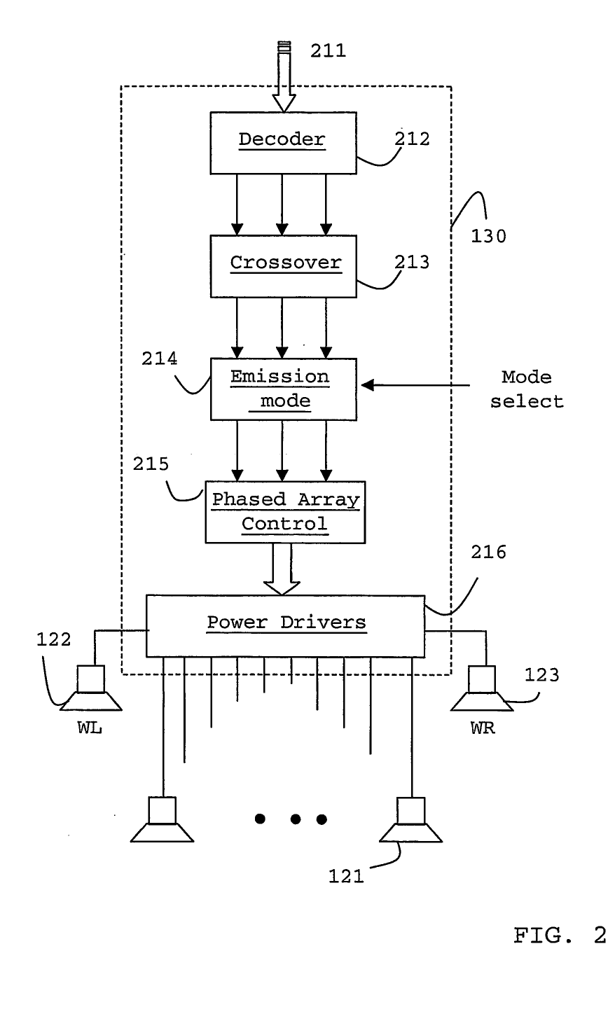

The basic block diagram of FIG. 2 shows the main components of the amplifier section 130. The multi-channel audio signal is assumed to arrive as an encoded digital bitstream 211. The digital data enter a decoder system 212 that separates the signal into the various audio channel signals including left L, right R and centre C channel, the surround channels SC (surround or rear left, surround or rear right etc.) and the low frequency effect channel LFE.

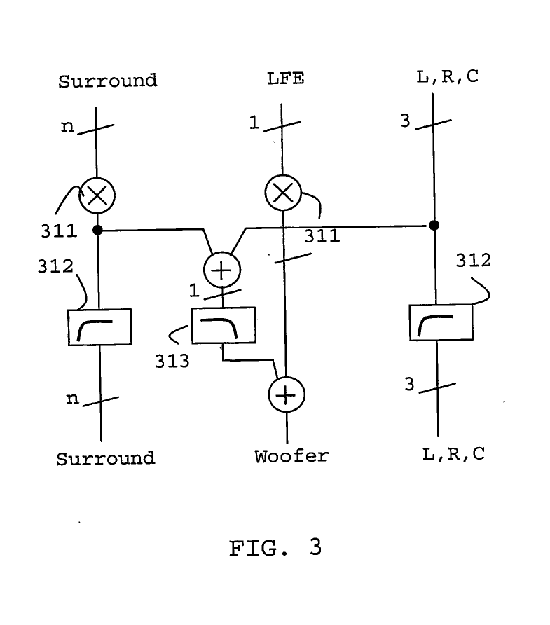

The thus decoded signals form the input to a crossover system 213 that controls the distribution of low frequency content among the various audio channels. As shown in FIG. 3, the n surround channels and the L,R, C channels after suitable gain adjustments 311 are both band split using high pass and low pass filters 312, 313 and their low frequency content is added together with the LFE signals to the Woofer channel to be ultimately emitted through the left and right woofer channels WL, WR. The high frequency content is passed on.

Other signals to be emitted through the WL and WR channels are determined by the emission mode control system 214 to be described below.

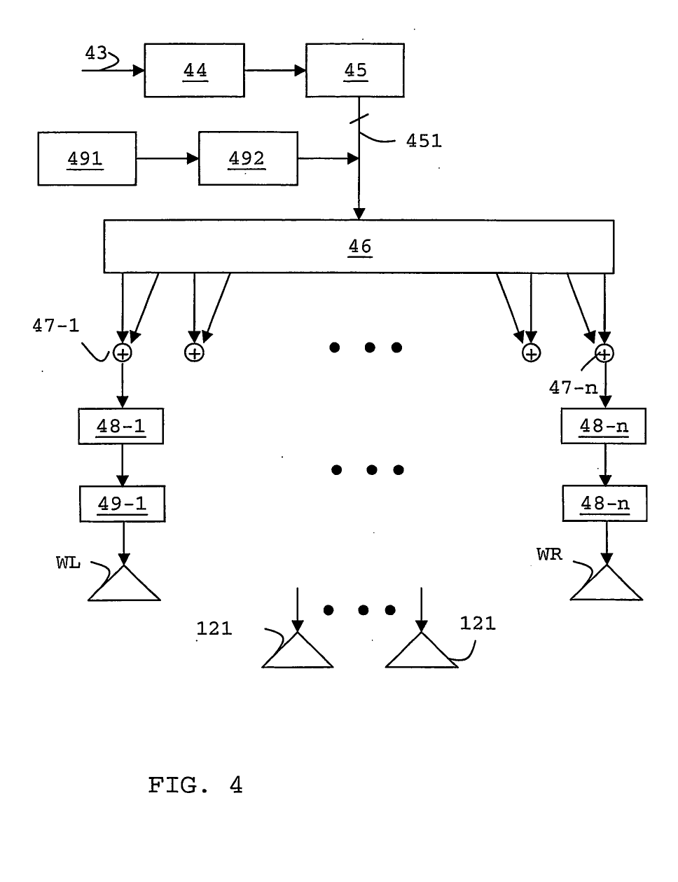

Both the crossover system 213 and the emission mode control system 214 shown in FIG. 2 are conveniently implemented as sub-sections of the digital signal processing unit 215 that controls the power driver units 216 for the entire phased transducer array 121 and the woofers WL, WR This system is capable of generating independently steerable narrow beams of sound to be either directly projected towards a listener or to be reflected from walls and/or ceiling. Such systems are available and can be purchased from the applicant 1Limited. Further details regarding the implementation and operation of a phased transducer array are described in the following with reference to FIG. 4.

In FIG. 4, the surround channels 43 provide the input to a multi-channel sample rate converter 44 for conversion to a standard sample rate and bit length. The outputs of the sample-rate-converter stage 44 are combined into a single high-speed serial signal comprising all channels.

The serialized data enters Digital Signal Processing (DSP) unit 45 to further process the data. The unit comprises a pair of commercially available Texas Instruments TMS320C6701 DSPs running at 133 MHz and performing the majority of calculations in floating point format.

The first DSP performs filtering to compensate for the irregularities in the frequency response of the transducers used. It provides four-times over-sampling and interpolation to remove high-frequency content generated by the oversampling process.

The second DSP performs quantization and noise shaping to reduce the word length to nine bits at a sample rate of 195 kHz.

The output from the second DSP is distributed in parallel using bus 451 to eleven commercially available Xilinx XCV200 field programmable gate arrays (FPGAs) 46. The gate arrays apply a unique time delay for each channel and for each transducer. Their output is a number of different versions or replicas of the input, the number being equal to the number of transducers times the number of channels. As the number of transducers 121 in this example is 74, several hundred different versions or replicas of the input are generated at this stage. The individual versions of the channels are summed at adders 47-1 to 47-n for each transducer and passed to pulse width modulators (PWM) 48-1 to 48-n. Each pulse width modulator drives a class-D output stage 49-1 to 49-n whose supply voltage can be adjusted to control the output power to the transducers 121. It is worth noticing that from a system control point of view the left and right woofer speakers WL, WR can be treated as the transducers 121 of the array.

System initialisation is under the control of a micro-controller 491. Once initialised the micro-controller is used to take direction and volume adjustment commands from the user via an infrared remote controller (not shown), display them on the system display, and pass them to a third DSP 492.

The third DSP 492 in the system is used to calculate the required time delay for each channel on each transducer to be able to steer each channel into a different direction. For example, a first pair of channels can be directed to the right and left side-walls (relative to the position of the surround-sound reproduction system) of a room while a second pair is directed to the right and left of the rear-wall to generate a surround sound. The delay requirements, thus established, are distributed to the FPGAs 46 over the same parallel bus 451 as the data samples. Most of the above steps are described in more detail in WO-0123104 which is incorporated herein by reference.

The microcontroller 491 and the DSP 492 control the emission mode by overlaying the channel information with an emission matrix controlling the output of the transducers 121.

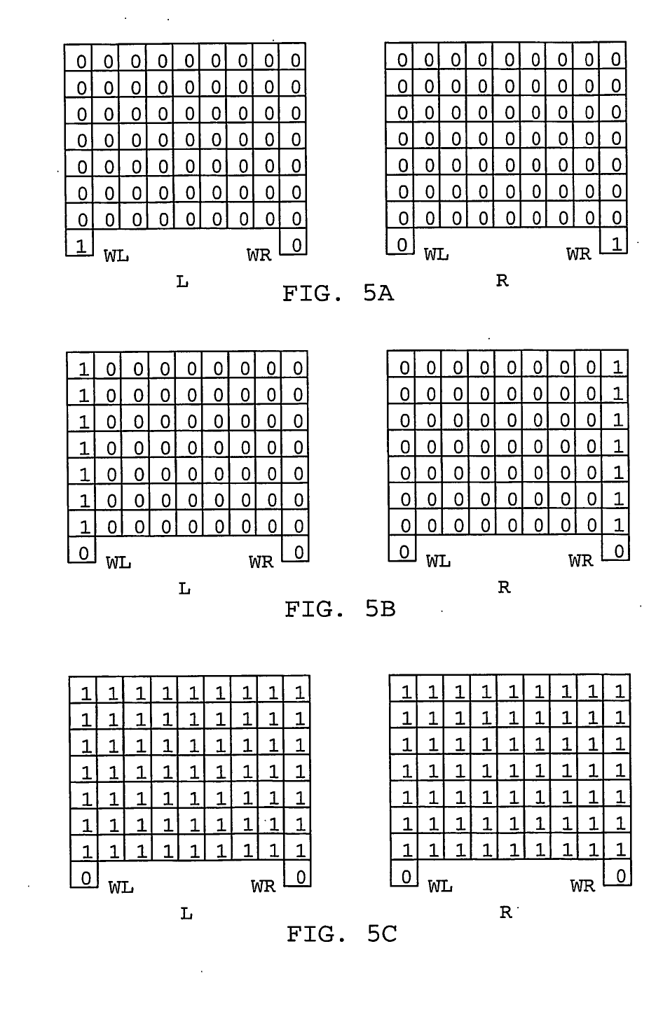

In the examples of FIG. 5, the emission matrix is an array or vector of n numbers wherein the position of the number in the array denotes the transducer controlled by the value of that number. The emission matrix can be implemented as a set of “1”s and “0”s. A “1” indicates that the transducer will output the channel in question while a zero blocks it.

Different emission modes are implemented by loading the corresponding emission matrices into the memory of the microcontroller. Three particular emission modes are contemplated for the left and right signal channel: The first L/R emission mode directs the left and right channel to the left and right woofers, respectively. In FIG. 5A, the matrix for this mode is shown with the bottom corner positions WL and WR representing the woofer transducers. The second L/R emission mode shown as matrix in FIG. 5B directs the left channel to the first column of transducers of the array and the right channel right to the last column of the transducer array, however, excluding the woofers. In the third emission mode as illustrated in FIG. 5C is a simple pass-through mode allowing the left and right channel to be emitted by the full array and therefore being emitted as a steerable beams. These beams are directed against reflecting surfaces and, after reflection, are perceived as stemming from the reflecting spots.

It is easy to see how the emission modes can be adapted to include other transducer configurations adding or subtracting transducers to emission channels as required. For example, low frequency content can be directed to a woofer loudspeaker located at the front face below or in the middle of the array.

1. An audio system for producing a plurality of surround-sound channels in response to an audio input signal, comprising
in a single enclosure an amplifier system adapted to receive surround sound input signals and a plurality of electro-acoustic transducers arranged in part as phased array and adapted to emit surround sound based on said surround sound input signals, wherein the enclosure includes at least one left and at least one right electro-acoustic transducer and filters to divert low-frequency content of said input signals for emission through said left and right transducers.

2. The audio system of claim 1 having the phased array mounted on a front face of the enclosure and the left and right transducers at respective side faces.

3. The audio system of claim 2 comprising a configuration system to select between predefined surround-sound emission modes, said modes activating and deactivating transducers for the emission of specific channels of the surround-sound.

4. The audio system of claim 3 wherein the configuration system selects between emission modes of a left and right channel of the surround-sound.

5. The audio system of claim 4 wherein the configuration system is adapted to switch the emission of the left and right channel to the left and right transducers, left and right columns of transducers of the phased array, the full phased array or a combination thereof, depending on a setting of external control signals.
